(19) United States
(12) Patent Application Publication
(10) Pub. No.: US 2015/0058782 A1
(43) Pub. Date: Feb. 26, 2015

(54) SYSTEM AND METHOD FOR CREATING AND INTERACTING WITH A SURFACE DISPLAY

(71) Applicant: INTEL CORPORATION, Santa Clara, CA (US)

(72) Inventors: Gershom Kutliroff, Alon Shvut (IL); Maoz Madmoni, Kibutz Bet Kamah (IL)

(73) Assignee: INTEL CORPORATION, Santa Clara, CA (US)

(21) Appl. No.: 13/972,621

(22) Filed: Aug. 21, 2013

(51) Int. Cl. G06F 3/0488; G06F 3/0481; G06F 3/0484

(52) U.S. Cl. CPC G06F 3/04886; G06F 3/04842; G06F 3/04815
USPC 715/773

(57) ABSTRACT

Systems and methods for projecting graphics onto an available surface, tracking a user's interactions with the projected graphics, and providing feedback to the user regarding the tracked interactions are described. In some embodiments, the feedback is provided via updated projected graphics onto the surface. In some embodiments, the feedback is provided via an electronic screen.

### BACKGROUND

Portable devices such as smart phones, tablets, and their associated hybrids (for example, “phablets”) have become a focus of the consumer electronics industry. To a large extent, their market success has been driven by advances in several key technology components, such as mobile processor SOC's (system on chip), display technologies, and battery efficiency. These developments have, in turn, increased the portability of the devices, as well as enabled additional functionality. Improvements in the core technology components are continuing, and the size of a portable device is largely limited by user input/output considerations, rather than the demands of the technology components. The size and, consequently, portability of a device is now primarily dependent on the size of its screen, its keyboard, and other input mechanisms.

### BRIEF DESCRIPTION OF THE DRAWINGS

Examples of a system that allows a display surface to be created and users to interact with the display surface are illustrated in the figures. The examples and figures are illustrative rather than limiting.

FIG. 1 is a diagram illustrating an example interaction of a user with an electronic device that has a projector, a camera, and a screen.

FIG. 2 is a diagram illustrating an example interaction of a user with an electronic device that has a projector and a camera.

FIGS. 3A-3F show graphic illustrations of examples of hand gestures that may be tracked.

FIGS. 4A-4D show additional graphic illustrations of examples of hand gestures that may be tracked.

FIG. 5 is a diagram illustrating an example model of a camera projection.

FIGS. 6A-6C are diagrams showing examples of surfaces onto which a display can be projected and an associated position of the camera used to monitor user interactions with the projected display.

FIG. 7A is a block diagram of a system for projecting a display on a surface and interpreting user interactions with the display.

FIG. 7B is a block diagram illustrating an example of components of a processor that generates a display for projection on a surface and interprets user interactions with the display.

FIG. 7C is a flow chart of an example process for identifying a projection surface and projecting an image onto the surface.

FIG. 8 is a flow chart of an example technique for detecting a surface within a depth image.

FIG. 9 is a diagram displaying an initial surface region and candidate bordering regions which may be annexed to the initial surface region.

FIG. 10 is a flow chart of an example process for detecting a display surface and initializing the surface model.

FIGS. 11A-11F show example images output from various stages during a process of detecting a display surface and initializing the surface model.

FIG. 12 is a flow chart of an example process for tracking a user's hand(s) and finger(s).

FIG. 13 is a diagram illustrating a camera and projector system.

FIG. 14 is a flow chart of an example process for projecting an image from a projector onto a surface.

FIG. 15 is a block diagram showing an example of the architecture for a processing system that can be utilized to implement tracking techniques according to an embodiment of the present disclosure.

### DETAILED DESCRIPTION

One solution to the challenge of providing a convenient user interface for portable devices with diminishing form factors is to project display graphics from the device onto any available surface, and allow the user to interact with the projected display as if it were a functioning touch screen. With this approach, the display is not restricted by the form factor of the device, and there is also no need to provide an integrated keyboard. By separating the input/output mechanism from the device, displays can be arbitrarily large, and user interactions far more varied, even while the devices continue to be designed to be smaller. The present disclosure describes systems and methods to enable such a user experience on portable projector-equipped devices.

Various aspects and examples of the technology will now be described. The following description provides specific details for a thorough understanding and enabling description of these examples. One skilled in the art will understand, however, that the technology may be practiced without many of these details. Additionally, some well-known structures or functions may not be shown or described in detail, so as to avoid unnecessarily obscuring the relevant description.

The terminology used in the description presented below is intended to be interpreted in its broadest reasonable manner, even though it is being used in conjunction with a detailed description of certain specific examples of the technology. Certain terms may even be emphasized below; however, any terminology intended to be interpreted in any restricted manner will be overtly and specifically defined as such in this Detailed Description section.

A user interface system can have two basic components. The first component displays information to the user, for example, a display screen, such as a flat panel display, or an image projected onto a vertical, flat wall. The display component shows the user a collection of graphical (or other) elements with which the user may interact.

The second component of the user interface system interprets the user's movements in relation to the information presented to the user by the display component. For example, a tablet may display information to the user on a flat panel display screen, and then interpret the user's movements by detecting where the user's fingers touch the screen relative to the displayed information. Generally, the user's actions have an immediate effect on the displayed information, and thus provide the user feedback that indicates how the user's actions were interpreted by the application running the user interface system on the electronic device with which the user is interacting. The present disclosure describes a user interface system in which the display component uses a projector that projects images onto an arbitrary surface, and the user interaction component identifies, tracks, and interprets the user's movements, as the user interacts with the graphics projected onto the surface.

A projector can be used to project an image or video onto a surface. Different technologies may be used to achieve this functionality. For example, a light may be shone through a transparent image, or the image may be projected directly onto the surface, for example, by using laser scanning technology. Handheld projectors, also known as pico projectors, may be integrated into portable devices such as cell phones, to project images and videos onto nearby surfaces. In the context of the present disclosure, any technology that is able to project graphical elements onto a surface may be used—for example, Digital Light Processing (DLP), beam-steering, or liquid crystal on silicon (LCoS).

According to the present disclosure, data is acquired by a depth camera for input about the environment and a user's movements, and a tracking component processes and interprets the information obtained by the depth camera, such as a user's movements. A depth camera captures depth images, generally a sequence of successive depth images, at multiple frames per second. Each depth image contains per-pixel depth data, that is, each pixel in each depth image has a value that represents the distance between a corresponding object in an imaged scene and the camera. Depth cameras are sometimes referred to as three-dimensional (3D) cameras.

A depth camera may contain a depth image sensor, an optical lens, and an illumination source, among other components. The depth image sensor may rely on one of several different sensor technologies. Among these sensor technologies are time-of-flight, known as “TOF”, (including scanning TOF or array TOF), structured light, laser speckle pattern technology, stereoscopic cameras, active stereoscopic sensors, and shape-from-shading technology. Most of these techniques rely on active sensors that supply their own illumination source. In contrast, passive sensor techniques, such as stereoscopic cameras, do not supply their own illumination source, but depend instead on ambient environmental lighting. In addition to depth data, the cameras may also generate color (“RGB”) data, in the same way that conventional color cameras do, and the color data can be combined with the depth data for processing.

The data generated by depth cameras has several advantages over that generated by RGB cameras. In particular, the depth data greatly simplifies the problem of segmenting the background of a scene from objects in the foreground, is generally robust to changes in lighting conditions, and can be used effectively to interpret occlusions. Using depth cameras, it is possible to identify and track both the user's hands and fingers in real-time, even complex hand configurations. Moreover, the present disclosure describes methods to project the graphical elements onto a display surface such that they are sharp and not distorted, and these methods may rely on the distance measurements generated by the depth camera, between the camera and objects in the camera's field-of-view.

U.S. patent application Ser. No. 13/532,609, entitled “System and Method for Close-Range Movement Tracking,” filed Jun. 25, 2012, describes a method for tracking a user's hands and fingers based on depth images captured from a depth camera, and using the tracked data to control a user's interaction with devices, and is hereby incorporated in its entirety. U.S. patent application Ser. No. 13/441,271, entitled “System and Method for Enhanced Object Tracking,” filed Apr. 6, 2012, describes a method of identifying and tracking a user's body part or parts using a combination of depth data and amplitude (or infrared image) data, and is hereby incorporated in its entirety in the present disclosure. U.S. patent application Ser. No. 13/676,017, entitled “System and Method for User Interaction and Control of Electronic Devices,” filed Nov. 13, 2012, describes a method of user interaction based on depth cameras, and is hereby incorporated in its entirety.

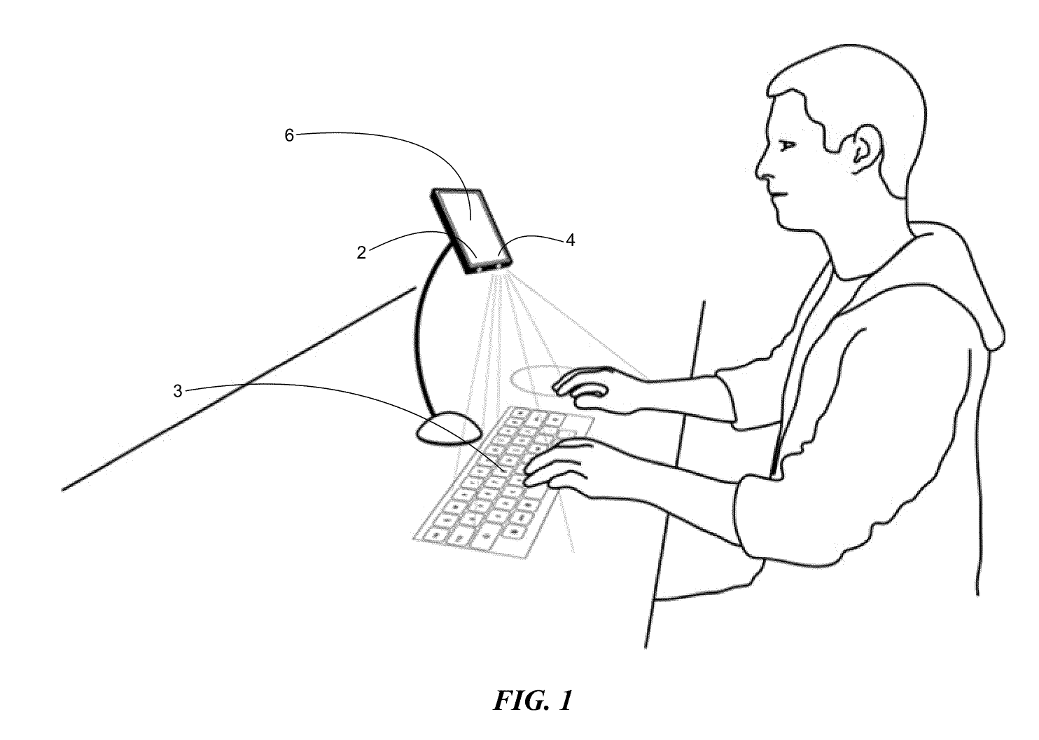

FIG. 1 is a diagram illustrating an example interaction of a user with an electronic device that has a projector 4, a camera 2, and a screen 6. The device uses the projector 4 to project a virtual keyboard 3 onto a surface, and the user interacts with the virtual keyboard, for example, making typing motions to enter text that may be viewed in the screen 6 of the device. The camera 2 captures data of the scene in real-time, and the data is processed by algorithms that interpret the poses and configurations of the user's hands relative to the projected keyboard.

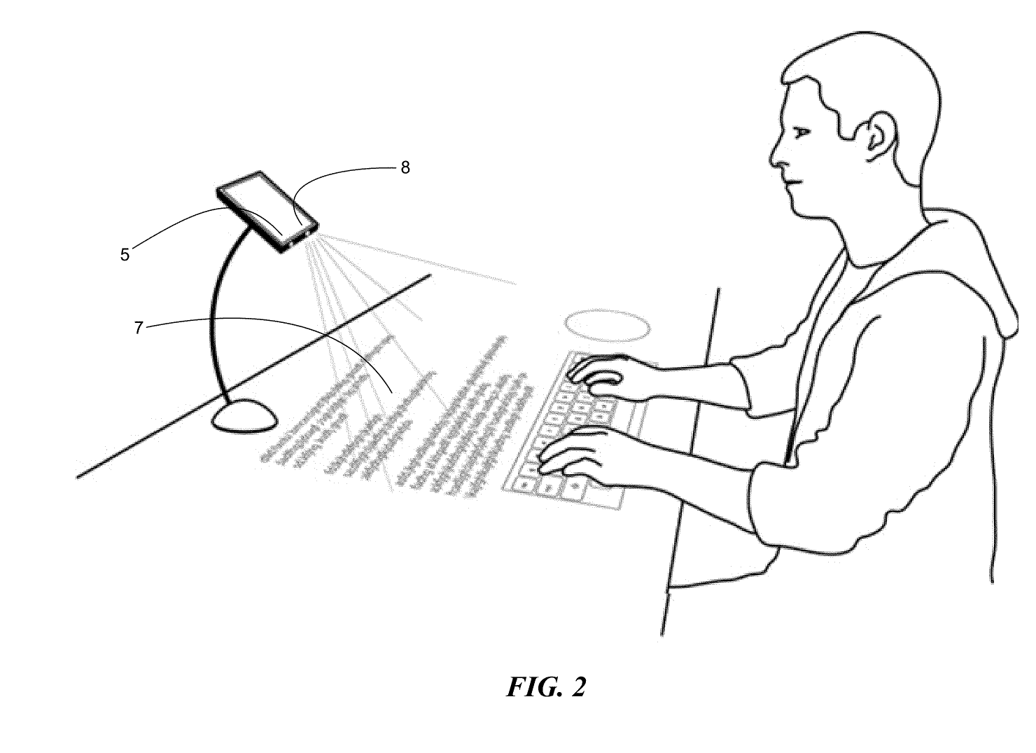

FIG. 2 is a diagram illustrating another example interaction of a user with an electronic device that has a projector 8 and a camera 5. The projector 8 projects graphics onto a display surface 7 for the user, and the user interacts with the surface 7. The camera 5 captures data of the scene in real-time, and the data is processed by algorithms that interpret the poses and configurations of the user's hands. In this embodiment, rather than providing feedback to the user on a screen of the electronic device, the feedback is provided in the graphics projected by the projector 8 onto the surface 7.

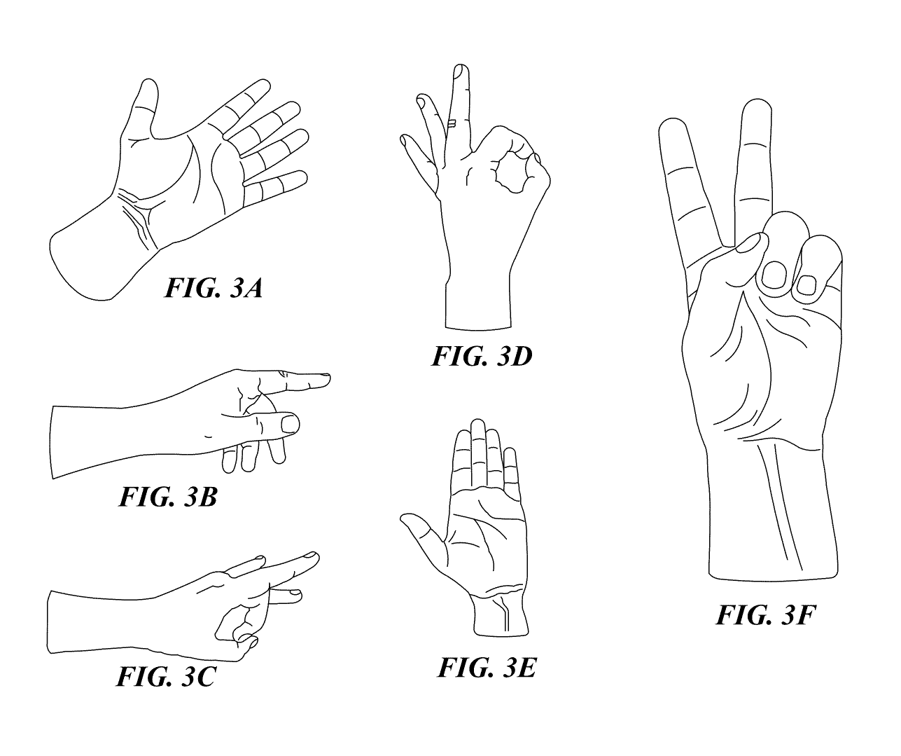

FIGS. 3A-3F show several example gestures that can be detected by the tracking algorithms. FIG. 3A shows an upturned open hand with the fingers spread apart. FIG. 3B shows a hand with the index finger pointing outwards parallel to the thumb and the other fingers pulled toward the palm. FIG. 3C shows a hand with the thumb and middle finger forming a circle with the other fingers outstretched. FIG. 3D shows a hand with the thumb and index finger forming a circle and the other fingers outstretched. FIG. 3E shows an open hand with the fingers touching and pointing upward. FIG. 3F shows the index finger and middle finger spread apart and pointing upwards with the ring finger and pinky finger curled toward the palm and the thumb touching the ring finger.

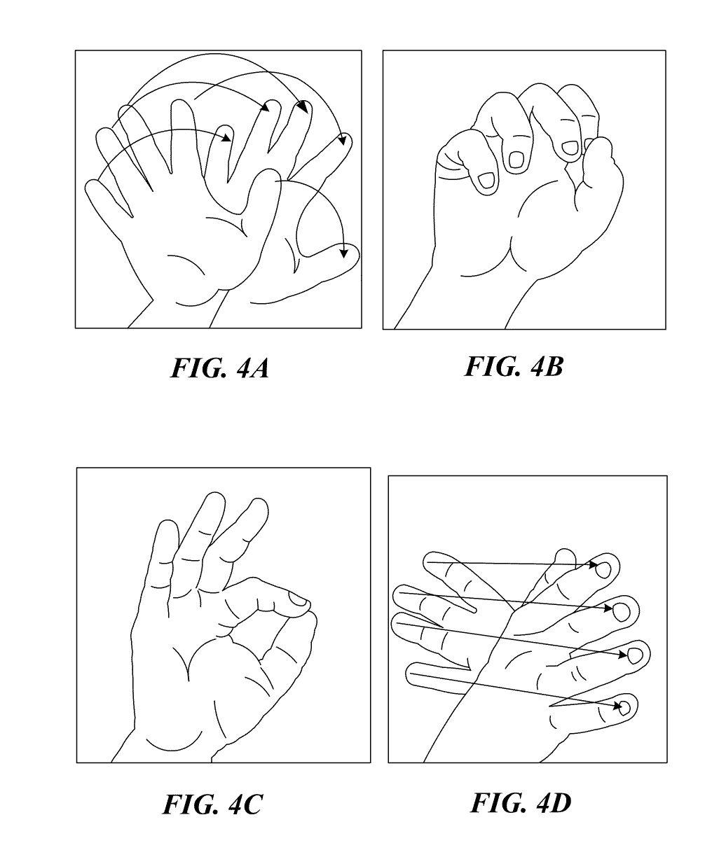

FIGS. 4A-4D are diagrams of an additional four example gestures that can be detected by tracking algorithms. The arrows in the diagrams refer to movements of the fingers and hands, where the movements define the particular gesture. FIG. 4A shows a dynamic wave-like gesture. FIG. 4B shows a loosely-closed hand gesture. FIG. 4C shows a hand gesture with the thumb and forefinger touching. FIG. 4D shows a dynamic swiping gesture. These examples of gestures are not intended to be restrictive. Many other types of movements and gestures can also be detected by the tracking algorithms.

The present disclosure utilizes a device which includes a projector and a depth camera. The projector projects a graphics display onto an arbitrary surface, and the depth camera acquires data which is used to identify and model the surface to be projected upon, and also to interpret the user's movements and hand poses. In some embodiments, the image projected may contain individual elements, and the user may interact with the elements by touching the surface upon which they have been projected. In this way, a touch screen experience is simulated without actually using a physical touch screen. In some embodiments, the pose of the hand may be detected, and this pose may be interpreted by the system to prompt different actions. For example, the user may touch a virtual object on the surface, form a grasping motion, and make a motion to pull the virtual object off of the table. This action may cause the virtual object to grow larger, or to disappear, or to be maximized, depending on the implementation chosen by the application developer. Similar types of interactions may also be implemented as embodiments of the present disclosure.

In some embodiments, the display may be projected onto parts of the user's body, such as the back of a hand, or an arm, and the user may then similarly interact with the projected display via the movements of the user's free hand(s). According to the present disclosure, the surface on which the display is projected may have an arbitrary 3D shape. The surface is not required to be flat, nor is it required to be rectangular.

Cameras view a three-dimensional (3D) scene and project objects from the 3D scene onto a two-dimensional (2D) image plane. In the present disclosure, “image coordinate system” refers to the 2D coordinate system (x, y) associated with the image plane, and “world coordinate system” refers to the 3D coordinate system (X, Y, Z) associated with the scene that the camera is viewing. In both coordinate systems, the camera is at the origin ((x=0, y=0), or (X=0, Y=0, Z=0)) of the coordinate axes.

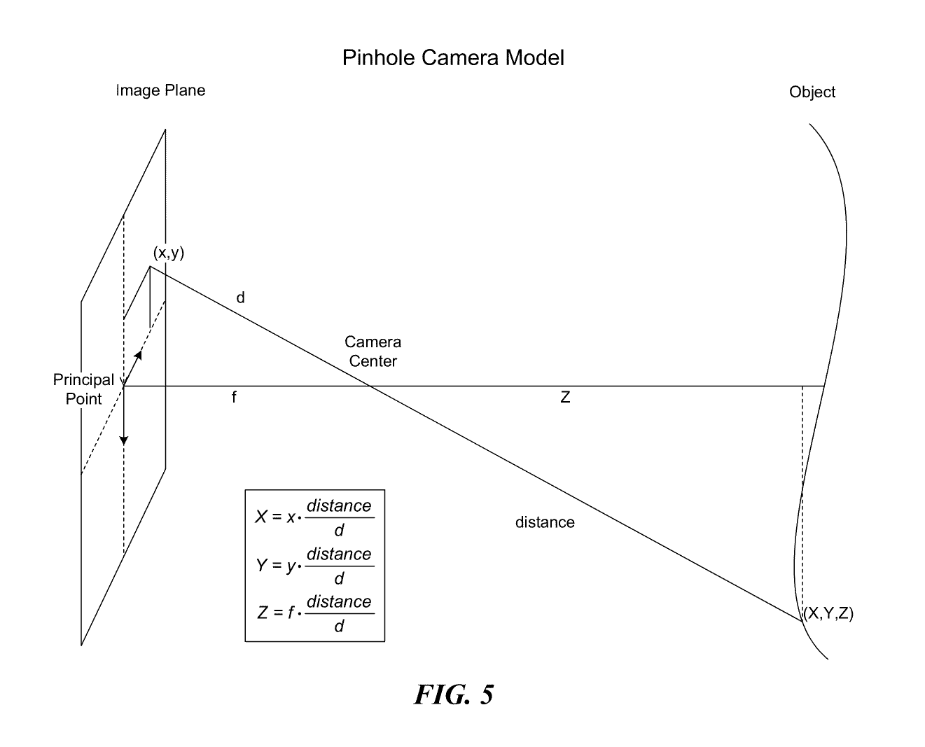

FIG. 5 is an example idealized model of a camera projection, known as a pinhole camera model. Since the model is idealized, for the sake of simplicity, certain characteristics of the camera projection, such as the lens distortion, are ignored. Based on this model, the relation between the 3D coordinate system of the scene, (X, Y, Z), and the 2D coordinate system of the image plane, (x, y), is:

$$X = x ( \frac{dist}{d} ) , \\ Y = y ( \frac{dist}{d} ) , \\ Z = f ( \frac{dist}{d} ) ,$$

where dist is the distance between the camera center (also called the focal point) and a point on the object, and d is the distance between the camera center and the point in the image corresponding to the projection of the object point. (The distances between the camera and objects are computed explicitly by depth cameras.) The variable f is the focal length and is the distance between the origin of the 2D image plane and the camera center (or focal point). Thus, there is a one-to-one mapping between points in the 2D image plane and points in the 3D world. The mapping from the 3D world coordinate system (the real world scene) to the 2D image coordinate system (the image plane) is referred to as the projection function, and the mapping from the 2D image coordinate system to the 3D world coordinate system is referred to as the back-projection function.

Since the display surface is arbitrary, it should be determined as part of the system initialization. In some embodiments of the present disclosure, the display surface may be selected explicitly by the user. For example, the user may point at a particular surface to indicate the region to be used as a display surface, and the pose of the user's hand may be tracked based on the data generated by the depth camera to interpret the user's gesture.

In some embodiments, the display surface may be selected automatically, by scanning the view of the depth camera, searching for suitable surfaces, and selecting the surface with the largest surface area. In some embodiments, the system may be constrained to only select specific surfaces as acceptable. For example, the system may be constrained to select only flat surfaces as display surfaces.

According to the present disclosure, certain constraints may be imposed on the shape and size of the surface. If these constraints are not satisfied, the user may be requested to re-position the system so as to change the camera's and projector's views, in order to find a surface that does satisfy the constraints. Once the surface is identified, the images projected by the projector may be adjusted to match the shape, size, and 3D orientation of the display surface. In the present disclosure, two techniques to discover an appropriate display surface are described.

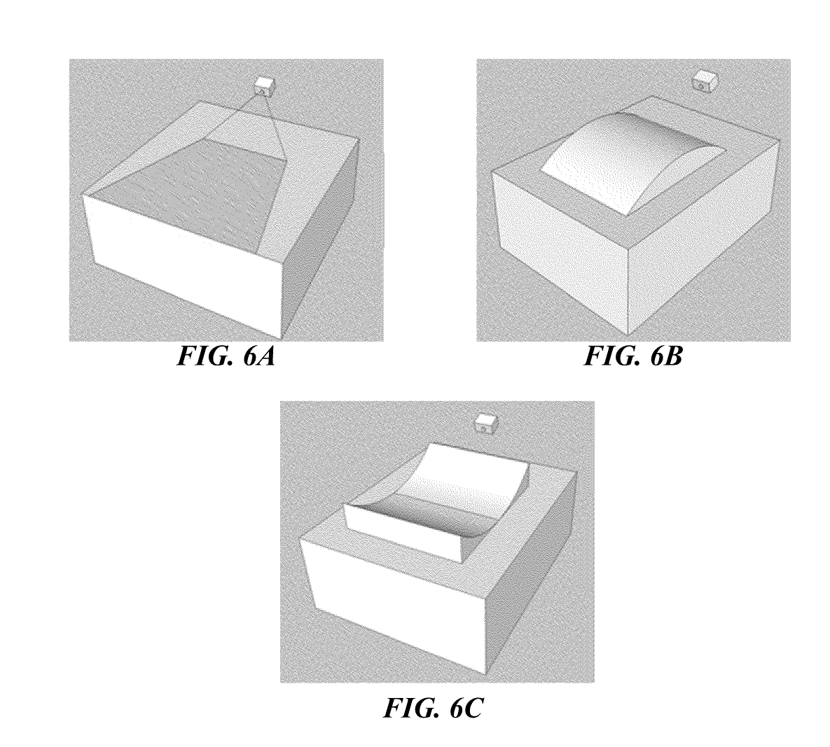

FIGS. 6A-6C are diagrams showing examples of surfaces onto which a display can be projected and an associated position of the camera used to monitor user interactions with the display. FIG. 6A shows a flat display surface; FIG. 6B shows a convex display surface; and FIG. 6C shows a concave display surface. These examples are non-limiting, and surfaces of even greater complexity may also be used.

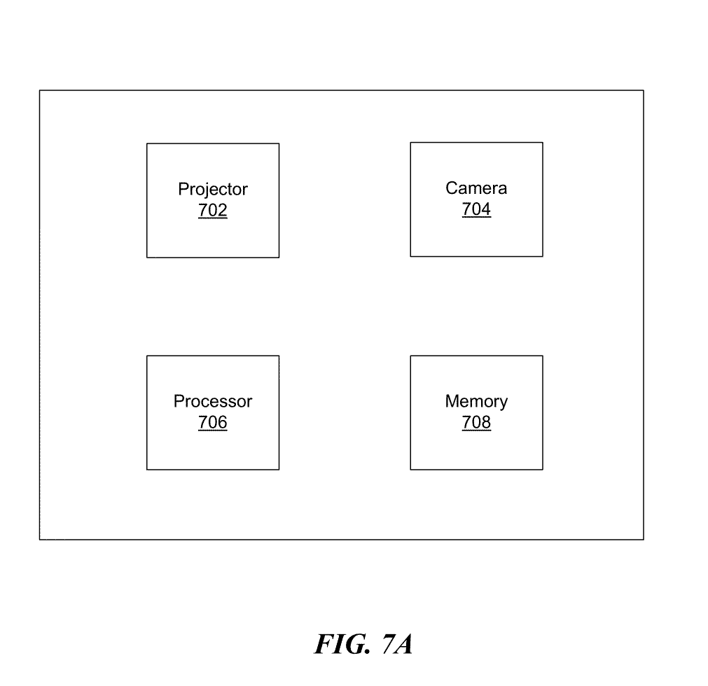

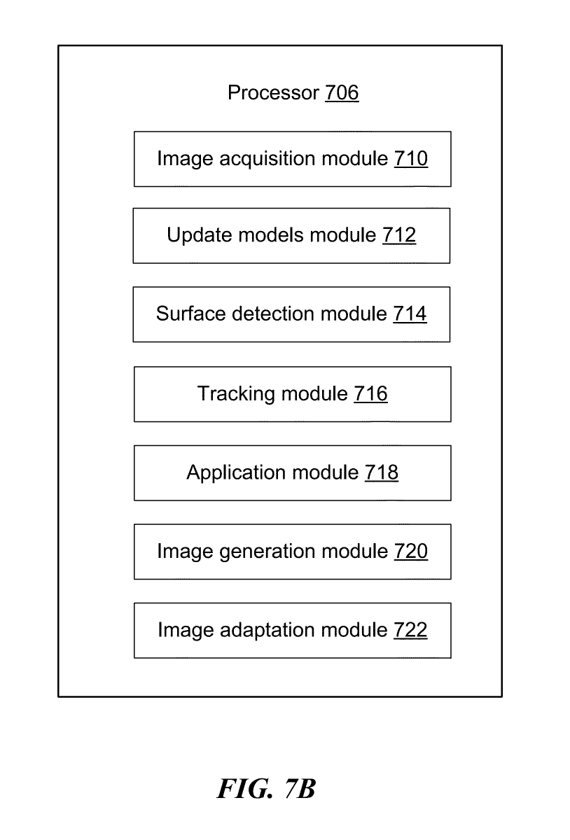

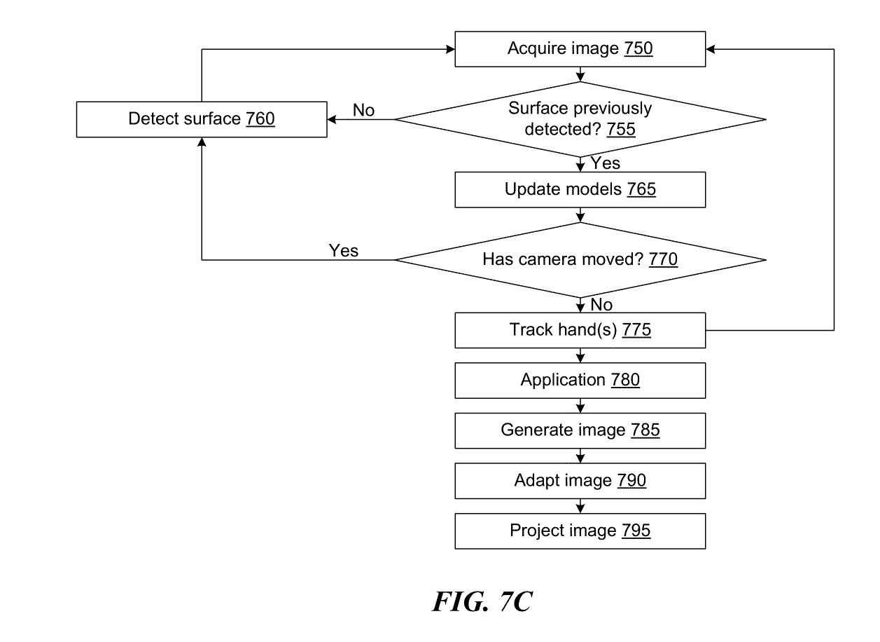

FIG. 7A is a block diagram of an example system for projecting a display on a surface and interpreting user interactions with the display. A depth camera 704 captures depth images at an interactive frame rate. As each depth image is captured, it is stored in a memory 708 and processed by the processor 706. Additionally, a projector 702 projects an image for the user to interact with, and the projector 702 can also project images that provide feedback to the user.

FIG. 7B is a block diagram illustrating an example of components that can be included in the processor 706, such as an image acquisition module 710, an update models module 712, a surface detection module 714, a tracking module 716, an application module 718, an image generation module 720, and/or an image adaptation module 722. Additional or fewer components or modules can be included in the processor 706 and each illustrated component.

As used herein, a “module” includes a general purpose, dedicated or shared processor and, typically, firmware or software modules that are executed by the processor. Depending upon implementation-specific or other considerations, the module can be centralized or its functionality distributed. The module can include general or special purpose hardware, firmware, or software embodied in a computer-readable (storage) medium for execution by the processor. As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, to name a few), but may or may not be limited to hardware.

FIG. 7C is a flow chart of an example process for identifying a projection surface and projecting an image onto the surface. At stage 750, the image acquisition module 710 stores each depth image as it is captured by the depth camera 704, where the depth images can be accessed by other components of the system, as needed. Then at decision stage 755, the surface detection module 714 determines whether a display surface has previously been detected.

If a display surface has not previously been detected (stage 755—No), at stage 760, the surface detection module 714 attempts to detect a display surface within the depth image. There are several techniques that may be used to detect the surface, two of which are described in the present disclosure, and either of which may be used at stage 760. The output of the surface detection module 714 is two models of the scene, the surface model and the background model.

The surface model is represented as an image with the same dimensions (height and width) as the depth image obtained at stage 750, with non-surface pixels set to “0”. Pixels corresponding to the surface are assigned the depth values of the corresponding pixels in the acquired depth image. The background model is represented as an image with the same dimensions (height and width) as the depth image obtained at stage 750, with non-background pixels, such as surface pixels, or pixels corresponding to foreground objects, set to “0”. Pixels corresponding to static, non-surface scene elements are assigned depth values obtained from the depth image acquired at stage 750. Because some pixels in one or both of these two models may not be visible at all times, the models are progressively updated as more information becomes visible to the depth camera. Furthermore, a mask is a binary image, with all pixels taking values of either “0” or “1”. A surface mask may be easily constructed from the surface model, by setting all pixels greater than zero to one. Analogously, a background mask may be easily constructed from the background model, in the same manner.

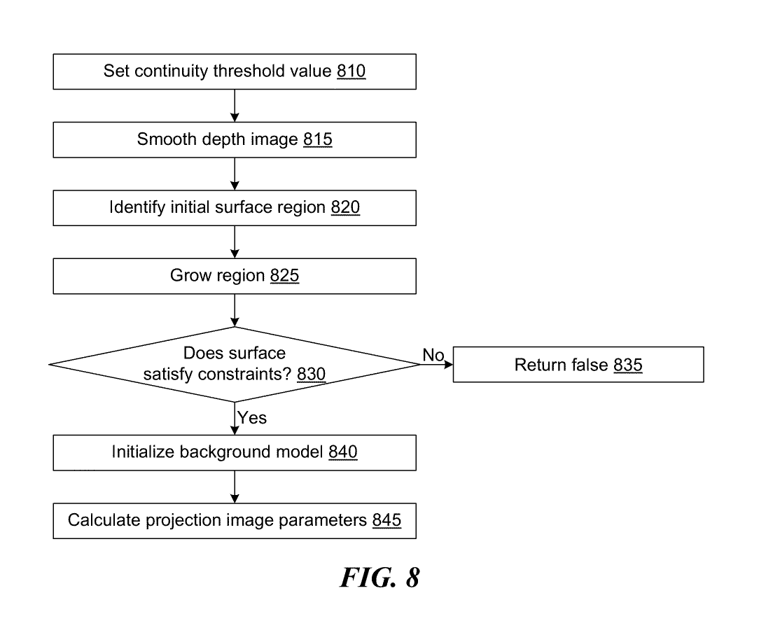

The surface detection module 714 detects a display surface from the depth image data, and initializes the surface model and the background model. FIG. 8 is a flow chart of a first example technique for detecting a surface within a depth image obtained by the depth camera 704. At stage 810, a continuity threshold value is set, on an ad hoc basis. The continuity threshold may differ from one type of camera to another, depending on the quality and precision of the camera's depth data. It is used to ensure a minimally smooth surface geometry. The purpose of the continuity threshold is described in detail below.

At stage 815, the depth image is smoothed with a standard smoothing filter to decrease the influence of noisy pixel values. Then at stage 820, the initial surface region set of pixels is identified. In some embodiments, the user explicitly indicates the region to be used. For example, the user points toward an area of the scene. Depth camera-based tracking algorithms may be used to recognize the pose of the user's hand, and then pixels corresponding to the surface indicated by the user may be sampled and used to form a representative set of surface pixels. In some embodiments, heuristics may be used to locate the initial surface region, such as selecting the center of the image, or the region at the bottom of the image.

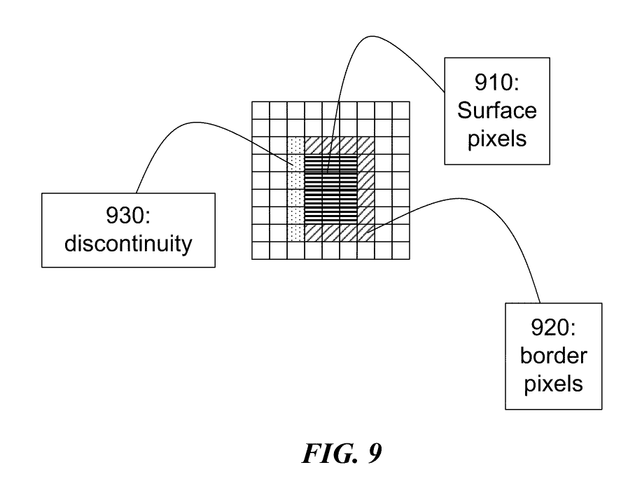

Next, at stage 825, the initial surface region is grown progressively outward, until the boundaries of the surface are discovered. FIG. 9 is a diagram displaying an initial surface region 910 and candidate bordering regions 920 which may be annexed to the initial surface region. The initial surface region 910 is shown shaded with horizontal lines, and the candidate bordering regions 920 are shown shaded with diagonal lines. A region 930 that is discontinuous from the surface region 910 is shown shaded by dots. All pixels belonging to the row or column that is in the bordering region 920 are evaluated to determine if the row or column should be annexed to the surface region 910. Either the entire row or column bordering the surface region 910 is annexed to the surface region 910, or it is marked as a discontinuous boundary 930 of the surface. This process may be repeated iteratively until the surface boundaries are defined on the four sides of the surface region 910.

In some embodiments, the initial surface region 910 is grown in the following way. First, the maximum pixel value over all pixels in the initial surface region, max_initSurface, is computed. Then, the region is progressively grown outward by a single row or column adjacent to the current region, in any of the four directions, until a discontinuity is encountered. If the difference between the maximum pixel value of a candidate row/column and max_initSurface exceeds the continuity threshold, this is considered a discontinuity, and the surface region is not allowed to grow further in that direction. Similarly, if the surface region reaches a boundary of the image, this image boundary is also considered a boundary of the surface region. When the surface region may no longer grow in any direction, the surface model is created by assigning to all pixels in the surface region their respective depth values from the depth image, and to all other pixels a value of zero.

Returning to FIG. 8, once the surface region has been identified, at decision stage 830, the surface region is analyzed to determine whether the constraints imposed by the system are met. Various types of constraints may be evaluated at this point. For example, one constraint may be that at least 50% of the total pixels in the image are part of the surface region set. An alternative constraint may be that the surface region pixels should represent a rectangular area of the image. If any of these constraints are not satisfied (stage 830—No), the surface detection module 714 returns false at stage 835, indicating that no valid surface was detected. The application module 718 may inform the user of this outcome, so the user can re-position the device in a way such that a valid surface is in the camera's field-of-view.

Returning to decision stage 830, if the detected surface does satisfy the system constraints (stage 830—Yes), then at stage 840, the background model is initialized as the complement of the surface model. In particular, every pixel equal to “0” in the surface model is assigned its original depth value in the background model. All pixels with non-zero values in the surface model are assigned “0” in the background model.

To project a sharp, undistorted image onto the surface, certain parameters of the surface, such as the shape, the size of the image, and its distance from the projector, should be taken into account. The distance from the projector to the surface is used to set the focus and the depth-of-field for the image to be projected. Once the surface model has been detected, the values of these parameters are computed at stage 845 by the image generation module 720.

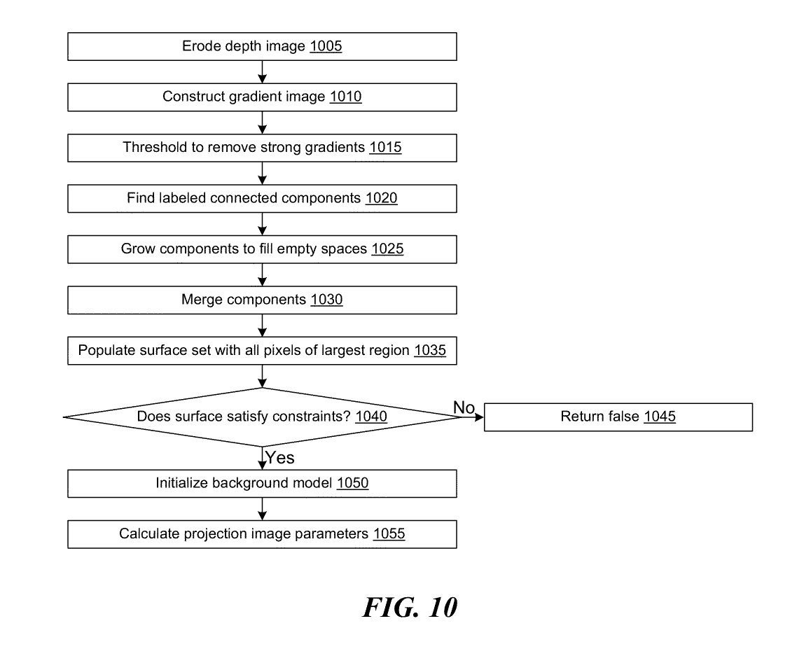

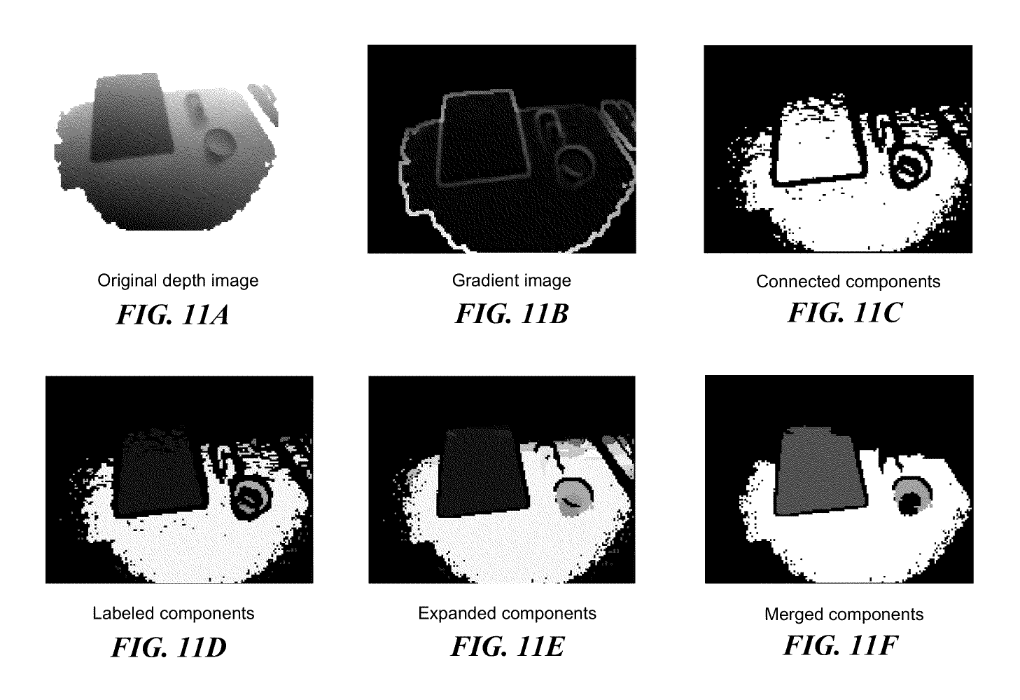

Note that in the method described above, the surface region is constrained to have a rectangular shape as a result of the way the initial surface region is grown outward. An alternative method for detecting the surface is now described, in which this constraint may be relaxed. FIG. 10 is a flow chart of an example process for detecting the display surface and initializing the surface model. This alternative technique allows for a more general shape for the surface, but has greater computing requirements and a higher implementation complexity. FIGS. 11A-11F show example images output from various stages during the example process shown in FIG. 10.

Based on the depth image acquired by the depth camera, a gradient image is produced, which contains the edges and discontinuities between the different objects in the depth image. This gradient image is produced by first eroding the original depth image at stage 1005, and then subtracting the eroded image from the original depth image at stage 1010.

A morphological operation filters an input image by applying a structuring element to the image. The structuring element is typically a primitive geometric shape, and is represented as a binary image. In one embodiment, the structuring element is a 5×5 rectangle. For a binary image A, the erosion of A by a structuring element B is defined as

A*B={x|Bₓ⊂A}

where

Bₓ={b+x|bεB} for all x

The erosion operation effectively “shrinks” each object in the two-dimensional image plane away from the object's borders, in a uniform manner. After the erosion operation is applied to the depth image, it is subtracted from the original depth image, to obtain the gradient image. FIG. 11A shows the original depth image from which a surface will be extracted. FIG. 11B shows an example gradient image output from stage 1010 where the borders of the silhouette are clearly distinguished.

Subsequently, at stage 1015, the gradient image is thresholded by a fixed value to remove the stronger gradients. That is, if the value of a depth image pixel is less than the threshold value (corresponding to a weak gradient), the pixel value is set to one, and if the depth value of the depth image pixel is greater than the threshold value (corresponding to a strong gradient), the pixel value is set to zero. The output of stage 1015 is a binary image.

Next, at stage 1020, the connected components of the binary thresholded gradient image are found, and each is assigned a unique label so that different regions are separated. For example, in FIG. 11C, all pixels are separated into different regions, depending on their locations and depth values. The regions of the image corresponding to the strong gradients effectively form the boundaries of these connected components. FIG. 11D shows an example of a labeled connected components image that is the output from stage 1020. At block 1025, the labeled connected components are then grown to cover more of the area of the image.

Growing the labeled connected components is an iterative process in which candidate pixels may be added to individual labeled components based on at least two factors: the candidate pixel's distance from the labeled component, and the cumulative variation of the pixel depth values between the labeled component and the candidate pixel. In some embodiments, a geodesic distance is used in the decision process for adding candidate pixels to labeled components. In the present context, the geodesic distance is the closest path between two pixels, where each pixel has a weight that depends on the variation in depth values over all pixels in the path. For example, the weight can be the sum of absolute differences between adjacent pixel depth values. If the weight is large, it is likely that the candidate pixel should not be grouped with that particular labeled component. For all pixels that are not yet assigned to components, geodesic distances can be computed to all components, and the pixel is added to the component associated with the lowest geodesic distance value. FIG. 11E is an example image of the output of stage 1025.

After the components are grown, some components that are proximate to one another (in terms of both their spatial and depth values) may be merged together at stage 1030. In addition, components that are too small, or that are beyond a certain distance from the camera, may be discarded at stage 1030. FIG. 11F is an example image of the output of stage 1030. Finally, at stage 1035, the component covering the largest percentage of the image may be chosen as the surface set. In the example of FIG. 11F, the surface set may be chosen as the rectangular-shaped object near the center of the image; thus the images would be projected onto this object, in this case. However, in general, the surface set can be the surface of any object or objects, such as the surface of a table.

Once the surface region has been computed, it is analyzed at decision stage 1040 to determine whether the constraints imposed by the system are met. There are various types of constraints that may be evaluated at this point. For example, one constraint may be that at least 50% of the total pixels are in the surface set. Alternatively, the surface pixels should have a particular geometrical shape (such as a circle). If any of these constraints are not satisfied (stage 1040—No), at stage 1045, the surface detection module 714 returns false, indicating that no valid surface was detected. The application module 718 may inform the user of this outcome, so the user can re-position the device in such a way that a valid surface is in the camera's field-of-view.

Returning to decision stage 1040, if the detected surface does satisfy the system constraints (stage 1040—Yes), then the background model is initialized as the complement of the surface model. In particular, every pixel equal to “0” in the surface model is assigned its original depth value in the background model. All pixels with non-zero values in the surface model are assigned “0” in the background model. To project a sharp, undistorted image onto the surface, certain parameters of the surface, such as the shape, the size of the image, and its distance from the projector, should be taken into account. The distance from the projector to the surface is used to set the focus and the depth-of-field for the image to be projected. Once the surface model has been detected, the values of these parameters are computed at stage 1055. This is the end of the second alternative process for detecting a surface.

Returning to FIG. 7C, if the surface model has previously been initialized (stage 755—Yes), at stage 765, the update models module 712 updates the surface and background models, and an additional set of pixels, referred to as the foreground set, is also computed.

As described above, the surface model is the depth image of all pixels corresponding to the surface (with all other pixels set to “0”), and the background model is the depth image of all pixels corresponding to the background (with all other pixels set to “0”). Because some portions of these two models may not be visible to the depth camera, the models are progressively updated as more information becomes visible. In some embodiments, the models are updated at every frame. Alternatively, they can be updated less often, for example, once every ten frames. In addition to the surface and background models, a foreground set is constructed at every frame that contains all pixels that are neither surface nor background pixels.

Updating the models based on the current depth image requires a surface proximity threshold value, which indicates how close pixel depth values are to the surface. The proximity threshold may be set on an ad hoc basis, and may be chosen to be consistent with the continuity threshold defined at stage 810. For example, the proximity threshold can be selected to be identical to the continuity threshold, or a factor of the continuity threshold, such as 1.5. Then, updating the surface and background models and populating the foreground pixel set is accomplished as follows. The current depth image is processed pixelwise. For any surface pixel (i.e., a pixel having a non-zero value in the surface model) that has a value within the surface proximity threshold of the surface, and is contiguous to the surface region, the surface model is updated to include this pixel. Alternatively, only if the pixel values of the entire row or column of pixels contiguous to the surface region have values within the surface proximity threshold of the surface, is the surface model updated to include this row or column. If the image pixel has a value which is larger than the corresponding surface pixel by at least the surface proximity threshold (indicating it corresponds to an object which is farther away from the camera than the surface), the background model may be updated with this pixel. If the image pixel has a value which is less than the corresponding surface pixel by at least the surface proximity threshold, it is included in the foreground set. Image pixels with values close to the surface, but not contiguous to the surface are also assigned to the background, and the background model is updated accordingly.

After the surface and background models and the foreground pixel set have been updated, at decision stage 770, a test is performed to check whether the camera has been moved. The surface model mask from the current frame is subtracted from the surface model mask of the previous frame. If there is a significant difference between the current and previous surface models, this indicates that the camera has moved (stage 770—Yes), and the surface detection module 714 is re-initialized. The amount of the difference between surface models may be defined per application and may depend on the camera frame rate, quality of the data and other parameters. In some embodiments, a difference of 10% of the total pixels in the image is used. If there is no significant change in successive surface models, at stage 775, the tracking module 716 tracks the user's hands and fingers or an object or body part moving in the depth images.

The set of foreground pixels includes the pixels corresponding to the user's hand(s) or moving object. This foreground pixel set is passed to the tracking module 716, which processes the foreground pixel set to interpret the configuration and pose of the user's hand(s) or object. The results of the tracking module 716 are then passed at stage 780 to the application module 718, which calculates a response to the user's actions. At stage 785, the application module 718 also generates an image to be shown on the display surface. For example, the generated image can provide feedback to the user by showing a representation of the user's tracked hands performing an action as interpreted by the tracking module 716 and/or an interaction of the representation of the user's hands with one or more virtual objects for interacting with an electronic device.

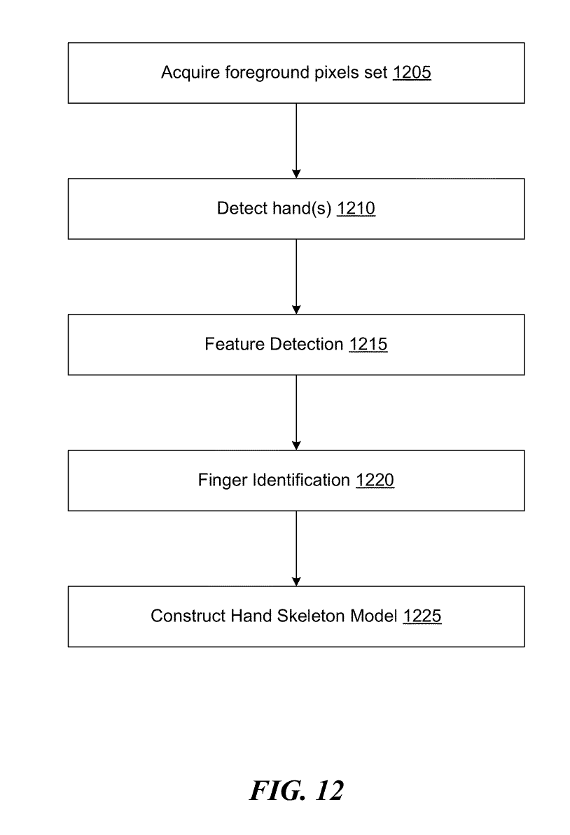

FIG. 12 is a flow chart of an example process of tracking a user's hand(s) and finger(s). At stage 1205, the foreground set of pixels is acquired, after it has been generated by the update models module 712 at stage 765. The set of foreground pixels contains the pixels associated with the user's hand(s), but may also contain additional pixels. The entire set of foreground pixels is processed in order to search for any hands in the depth image at stage 1210. The term “blob” is used to represent a group of contiguous pixels. In some embodiments, a classifier is applied to each blob of the set of foreground pixels, and the classifier indicates whether the shape and other features of a blob correspond to a hand. (The classifier is trained offline on a large number of individual samples of hand blob data.) In some embodiments, hand blobs from previous frames are also used to indicate whether a blob corresponds to a hand. In some embodiments, the hand's contour is tracked from previous frames and matched to the contour of each blob from the current frame. Once the hand blob is found, all other pixels of the foreground are discarded.

Subsequently, features are detected in the depth image data and/or associated amplitude data and/or associated RGB images at stage 1215. These features may be, for example, the tips of the fingers, the points where the bases of the fingers meet the palm, and any other image data that is detectable. The features detected at stage 1215 are then used to identify the individual fingers in the image data at stage 1220.

The 3D points of the fingertips and some of the joints of the fingers may be used to construct a hand skeleton model at stage 1225. The skeleton model may be used to further improve the quality of the tracking and assign positions to joints which were not detected in the earlier stages, either because of occlusions, or missed features, or from parts of the hand being out of the camera's field-of-view. Moreover, a kinematic model may be applied as part of the skeleton, to add further information that improves the tracking results. U.S. application Ser. No. 13/768,835, titled “Model-Based Multi-Hypothesis Target Tracker,” filed Feb. 15, 2013, describes a system for tracking hand and finger configurations based on data captured by a depth camera, and is hereby incorporated in its entirety.

The size of the projected image may be adjusted based on the size and shape of the display surface, as well as the distance from the projector to the display surface. For example, if the device is projecting onto a user's hand, it may be desirable to only project the parts of the image that fit onto the hand. The image generated by the application is adapted by the image adaptation module 722 at stage 790 based on the particular shape of the display surface, so that it is sharply focused, and not distorted. The relevant parameters that determine how the image should be adjusted to the particular shape and characteristics of the display surface were previously derived by the surface detection module 714 at stage 760. Finally, the image is projected onto the display surface at stage 795 by the projector 702. Then control is passed back to the image acquisition module 710 at stage 750, for processing the next depth image.

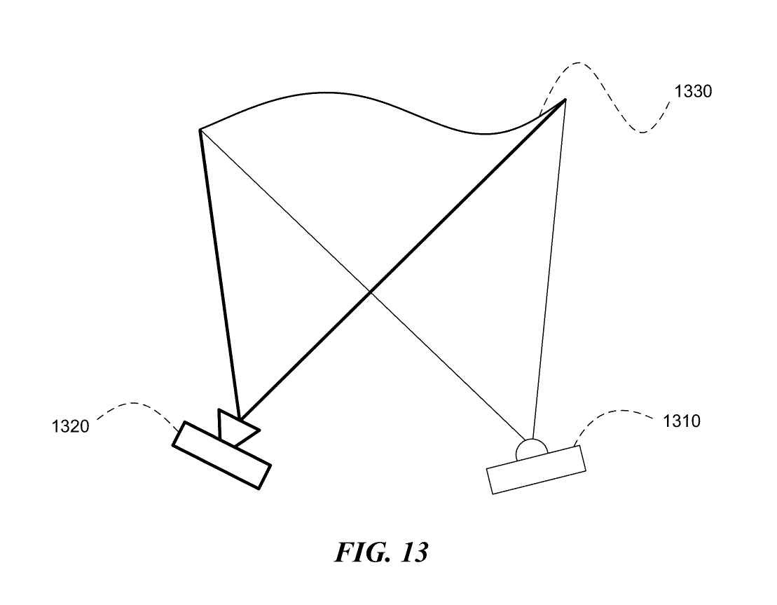

FIG. 13 is a diagram illustrating a system having a camera 1310, a projector 1320, and a surface 1330. The camera 1310 views the surface 1330 and captures data which is processed by the surface detection module 714 to analyze the shape of the surface 1330, and the projector 1320 projects a graphics image onto the surface 1330. In some embodiments, the positions of the camera and the projector are fixed, relative to one another. Both the camera and the projector have independent local coordinate systems, and the transformation from one coordinate system to the other may be represented by a 3×4 transformation matrix T. In particular, this transformation T is a rotation and translation, and may be written as T=[R|t], where R is a 3×3 matrix that is the first three columns of the matrix T, and t is a 3×1 column vector that is the fourth column of the matrix T. Furthermore, the camera and the projector each have a mapping between 3D world coordinates, and the 2D image plane, where the transformation from 2D to 3D is the back-projection function, and the transformation from 3D to 2D is the projection function.

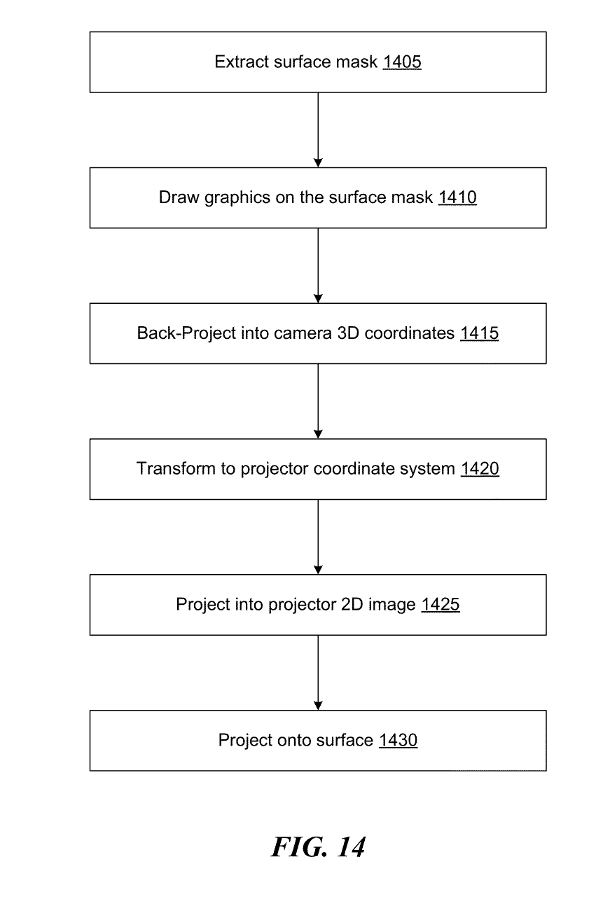

FIG. 14 is a flow chart of an example process of projecting an image from the projector onto a surface, according to the system illustrated in FIG. 13. Initially, at stage 1405, the surface is detected by the surface detection module 714 from the depth image captured by the camera and a surface mask is generated, as described above. Then at stage 1410, the image to be projected is constructed on a 2D representation of the surface mask. At stage 1415, each pixel is back-projected from the 2D image into the 3D world coordinates, using the camera's back-projection function. At stage 1420, once the points are in 3D world coordinates, they may be transformed to the local coordinate axis of the projector, using the transformation matrix T. Using the projector's projection function, each point is then projected onto the 2D projector image plane at stage 1425. Finally, at stage 1430, this image is projected onto the surface. In some embodiments, the pixel resolution may be scaled up or down to account for different resolutions between the camera and the projector.

In some embodiments of the present disclosure, the surface may be modeled explicitly, by an equation in 3D space with the general form:

$${\sum }_{i} {a}_{i} {x}^{i} + {\sum }_{j} {b}_{j} {y}^{j} + {\sum }_{k} {c}_{k} {z}^{k} + {\sum }_{l} {d}_{l} {x}^{l} y + … + {\sum }_{m} {e}_{m} {yz}^{m} + {\sum }_{n} {f}_{n} xyz + … + g = 0$$

The constants aᵢ, bⱼ, cₖ, . . . , g are determined from a set of 3D points on the display surface, where the size of this set depends on the number of degrees of the surface equation. For example, if the surface equation is constrained to be a flat plane, the relevant equation is

ax+by +cz+d=0,

and three non-collinear points on the surface are used to solve for the constants a, b, c, d.

In some embodiments of the present disclosure, the positions of the joints of the user's hands, as computed by the tracking module 716, are monitored to determine whether the user touched the surface. For example, if the distance between a 3D joint position and the nearest point of the surface model is within a certain threshold (to account for possible noise in the camera data), a touch event may be generated.

In some embodiments, the image that is projected may exclude the foreground set, as it is computed in the update models module 712. In this way, foreground objects, including the user's hand, may not interfere with the image that is projected onto the surface. Furthermore, the projected graphics image may be adapted at each frame to the portion of the surface region that is not blocked from the projector's view.

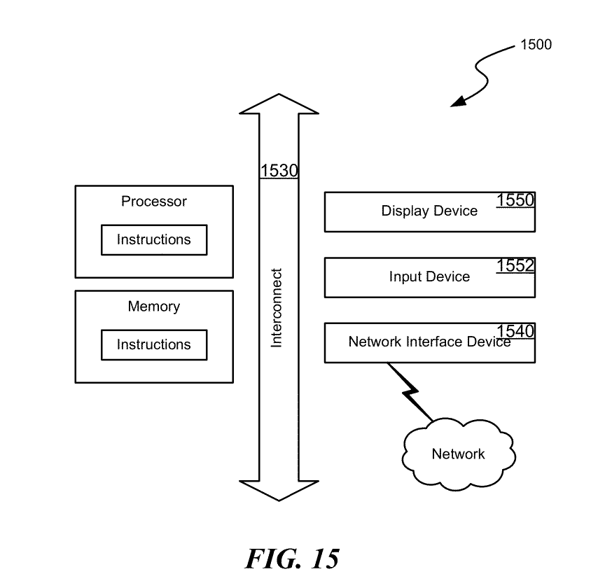

FIG. 15 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

### CONCLUSION

Unless the context clearly requires otherwise, throughout the description and the claims, the words “comprise,” “comprising,” and the like are to be construed in an inclusive sense (i.e., to say, in the sense of “including, but not limited to”), as opposed to an exclusive or exhaustive sense. As used herein, the terms “connected,” “coupled,” or any variant thereof means any connection or coupling, either direct or indirect, between two or more elements. Such a coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. While processes or blocks are presented in a given order in this application, alternative implementations may perform routines having steps performed in a different order, or employ systems having blocks in a different order. Some processes or blocks may be deleted, moved, added, subdivided, combined, and/or modified to provide alternative or subcombinations. Also, while processes or blocks are at times shown as being performed in series, these processes or blocks may instead be performed or implemented in parallel, or may be performed at different times. Further any specific numbers noted herein are only examples. It is understood that alternative implementations may employ differing values or ranges.

The various illustrations and teachings provided herein can also be applied to systems other than the system described above. The elements and acts of the various examples described above can be combined to provide further implementations of the technology.

Any patents and applications and other references noted above, including any that may be listed in accompanying filing papers, are incorporated herein by reference in their entireties. Aspects of the technology can be modified, if necessary, to employ the systems, functions, and concepts included in such references to provide further implementations of the technology.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

While certain aspects of the technology are presented below in certain claim forms, the applicant contemplates the various aspects of the technology in any number of claim forms. For example, while only one aspect of the technology is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the technology.

What is claimed is:

1. A method comprising:
projecting an image onto a surface;
acquiring depth data of a user interacting with the projected image on the surface;
processing the user's interactions with the projected image;
causing to be displayed to the user feedback on results of the processing of the user's interactions with the projected image.

2. The method of claim 1, wherein causing to be displayed to the user feedback comprises projecting an updated image onto the surface.

3. The method of claim 1, wherein the feedback is displayed on an electronic screen.

4. The method of claim 1, wherein the user's interactions with the projected image include using gestures to indicate a selection or movement of one or more objects in the projected image, the method further comprising tracking the user's gestures using the acquired depth data, wherein the processing is based on the tracked gestures.

5. The method of claim 1, wherein the user's interactions with the projected image includes touching one or more locations on the projected image to select or move one or more objects in the projected image.

6. The method of claim 1, further comprising:
capturing an initial depth image of a first region using a camera;
automatically detecting within the first region the surface for projecting the image onto, wherein the surface satisfies one or more conditions.

7. The method of claim 6, further comprising:
providing information to the user that no surface within the first region satisfies the one or more conditions when no surface satisfies the one or more conditions;
requesting the user to reposition the camera to allow a second depth image of a second region to be captured for detecting a suitable surface for projecting the image onto.

8. The method of claim 1, further comprising:
acquiring an initial depth image of the user indicating the surface for projecting the image onto.

9. The method of claim 1, wherein the surface is on a portion of the user's body.

10. The method of claim 1, further comprising:
calculating a surface model and a background model, wherein the surface model is a first set of data corresponding to the surface, and further wherein the background model is a second set of data corresponding to an image background,
wherein the surface model and the background model are updated periodically.

11. The method of claim 10, wherein the surface model and the background model are updated for each captured depth data frame.

12. The method of claim 10, further comprising:
calculating a foreground model from the surface model and the background model, wherein the foreground model is a third set of data that includes objects in a foreground of a depth image,
wherein the projected image does not include portions that would be projected onto objects in the foreground.

13. A system comprising:
a depth camera configured to capture depth images;
a projector configured to project generated images onto an imaging surface;
a processing module configured to:
track a user's movements from the captured depth images, wherein the user's movements interact with the projected generated images to select or move one or more objects in the projected generated images;
provide feedback to the user based upon the interaction of the user's movements with the projected generated images.

14. The system of claim 13, wherein the feedback is provided via the projected generated images.

15. The system of claim 13, wherein the feedback is provided via an electronic screen.

16. The system of claim 13, wherein the processing module is further configured to automatically detect in a first depth image the imaging surface for projecting the generated images onto.

17. The system of claim 16, wherein the processing module is further configured to:
determine whether the imaging surface satisfies one or more conditions;
requesting the user to reposition the depth camera to acquire a second depth image for detecting a suitable imaging surface for projecting the generated images onto.

18. The system of claim 13, wherein the depth camera captures user depth images, and further wherein the processing module is further configured to identify a specific surface indicated by the user in the user depth images as the imaging surface.

19. The system of claim 13, wherein the processing module is further configured to:
calculate a surface model and a background model, wherein the surface model is a first set of data corresponding to the imaging surface, and further wherein the background model is a second set of data corresponding to an image background,
wherein the surface model and the background model are updated periodically.

20. A system comprising:
means for projecting graphics onto a surface;
means for acquiring depth images of a user interacting with the projected graphics on the surface;
means for processing the user's interactions with the projected graphics;
means for displaying to the user feedback on results of the processing of the user's interactions with the projected graphics.
